(19) United States
(12) Patent Application Publication
(10) Pub. No.: US 2003/0085492 A1
(43) Pub. Date: May 8, 2003

(54) Method for producing a fastener part

(76) Inventor: Axel Schulte, Holzgerlingen (DE)

Correspondence Address: Mark S Bicks, Roylance Abrams Berdo & Goodman, Suite 600, 1300 19th Street NW, Washington, DC, 20036, US

(21) Appl. No.: 10/182,369

(22) PCT Filed: Nov. 7, 2001
(86) PCT No.: PCT/EP01/12841

(51) Int. Cl. B29C 69/00

(52) U.S. Cl. 264/443; 264/167

(57) ABSTRACT

The invention relates to a method for producing a fastener part consisting of plastic materials and comprising a strip or film-type support part (20), which is provided with a plurality of hook elements on at least one of its two sides. Each hook element has a head part (32), which is connected to the support part (20) by a stem part (30). To obtain different geometric forms for the head parts (32), which are wider in relation to the stem parts (30), a thermoplastic molding process is used, which acts on the free ends of the stem parts (30). As the thermoplastic molding process is carried out using ultrasound and the head parts are molded by means of a molding tool that comes into contact with the free end of the stem parts (30), hook elements with variable head shapes or geometric forms can be produced in a material-saving manner without using the usual calendar rolling methods.

The invention relates to a process for production of an adherent fastening element of plastic material with a strip or foil backing element, on at least one of its two sides provided with a plurality of interlocking elements each having a head component which is connected to the backing element by way of a stalk component, a thermoplastic shaping process acting on the free ends of the stalk components being employed in order to obtain head components of different geometric configurations which are widened in comparison to the stalk components.

DE 198 28 856 C1 discloses a process for production of an adherent fastening element, with a plurality of interlocking elements integral with a backing element, in which process a thermoplastic material is introduced into the gap between a pressure tool and a shaping tool, a process in which a sieve having through openings is used as preshaping element on the shaping tool and in which the interlocking elements are formed by at least partial setting of the thermoplastic in the openings in the sieve. The shaping tool is in this process modified so that, on the side of the sieve facing away from the pressure tool, a preshaping element interacting with the openings in the sieve is present by which the plastic material in the area of the outer ends of the stalk components is shaped.

The outer ends of the stalk components referred to then form a sort of head component; the edges or the rotary edge of the respective head components may be raised. Such raising occurs especially during the deformation process, in which the backing element with the preshaped stalk components are extracted from the shaping cavities of the shaping tool. If raised edges such as this occur on the end of the stalk components, a so-called calendering process may then follow, a process in which a calender roller acts on the raised ends of the stalk components, presses these ends downward and in the process forms flat interlocking elements whose edges project downward. The interlocking elements thereby produced are then interlockable and may be detachably engaged with the hook or loop material of another corresponding adherent fastening. The interlocking head components produced by the calendering process may be produced in a plurality of geometric dimensions and with an extremely wide variety of external outlines, such as round, oval, polygonal, hooklike, and/or including formation of a plurality of interlocking elements on the outer circumference with incisions along their edge.

PCT/WO 00/41479 also discloses provision of the upper side of the calender roller referred to with a type of sandpaper structure in order to effect roughening of the head component material on its free end. It is stated that increased peel strength is achieved for the conventional fastening, the free ends of the stalk components being heated to their softening temperature in advance of the calendering process itself, while the remaining fastening material, including the backing element, has imparted to it a temperature which is distinctly lower than this softening temperature. In particular in the case of so-called microadherent fastenings, in which the stalk and head components have markedly small geometric dimensions, this conventional process is poorly suited for increasing peel strength, since the calender roller with its roughened surface damages the micro mushrooms as interlocking elements and to some extent makes them unusable. This is additionally promoted by retention of the softening temperature in the plastic material on the free ends of the stalk component involved resulting in plasticization processes which are difficult to control, with the consequence that the head shapes desired cannot be obtained; these head components rather assume indeterminate contour configurations, in particular around their edges.

DE-A-33 25 021 discloses a device for production of hooks on surface zip fasteners with loops and hooks. In the case of the conventional solution use is made of a loop strip consisting of a base fabric and a plurality of projecting loops in the form of monofilaments of thermoplastic synthetic resin which are knitted or woven into the base fabric. The respective loop produced is cut through on the basis of a cutting device based on ultrasound and an interlocking hook is produced whose interlocking path remains the same in diameter.

DE-A-42 20 908 discloses as generic process for production of interlocking elements, a pile fabric for surface zip fasteners with relatively rigid pile threads being produced from a thermoplastic. The projecting ends of the pile threads, which form a sort of stalk component, are melted on by heating to form mushroomlike hooks, the mushrooms produced in this manner being wider in diameter than the stalk components. The pile threads consist of monofilaments of a material in the form of polypropylene, for example. The projecting ends of these pile threads are melted on the mushrooms by the radiative heat of the thermoplastic shaping process, free of contact and by thermal shock. A differentiated head shaping process is not possible with the conventional solution and, depending on the heat applied, the possibility exists that the mushrooms obtained may be damaged and no longer available for a process of interlocking with other fastening elements.

On the basis of this state of the art the object of the invention is further improvement in the conventional processes to the end that interlocking elements with variable, precisely definable head shapes or head geometries may be produced by a process conserving materials while avoiding otherwise customary calendering processes and contact-free heat application processes. An object as formulated in these terms is achieved by a process having the features specified in claim 1 in its entirety.

As a result of the fact that, as specified in the descriptive portion of claim 1, the thermoplastic shaping process is executed by means of ultrasound and that a shaping tool is used to effect shaping of the head components during contact with the free end of the stalk components (30), a shaping process is conducted which results in especially extensive conservation of plastic material. In addition, the treatment of the fastening element with ultrasonic waves permits application of a precisely defined amount of energy to the fastening material, harmful thermal spikes being prevented. In addition, the shaping process involving the use of ultrasound permits a very broad shaping range for head components; it is surprising how large is the number of the widest variety of precisely definable head shapes that may be created, something not possible up to the present with conventional production processes. The head shapes may prescribed with precision on the basis of their geometric configurations, since the shaping tool by means of which ultrasonic waves are introduced into the fastening material to be shaped can be produced with high accuracy, in contrast to the calender rollers with very large diameters, which exhibit varying diameter ranges and variable synchronism in operation, especially when they are heated. To the extent that the conventional processes provide a process of heat introduction by means of a heat introduction source, the head shapes cannot be obtained with geometric precision on the basis of assigned dimensions, while the possibility of damage to or even melting off of the head shapes due to damaging introduction of heat is also not to be excluded.

In a preferred embodiment of the process claimed for the invention, the shaping process by means of ultrasound is comparable to an ultrasonic welding process, the sonotrodes and/or counterhold element for the sonotrodes being provided with individual shaping elements by means of which the assignable head shapes may be produced. The respective shaping tools in the form of the sonotrodes and in the form of the counterhold element (anvil) can be cost effectively produced and operated, in contrast to the calender shaping solution, which is costly from the technical viewpoint.

In another preferred embodiment of the process claimed for the invention, the shaping elements are arranged in assignable rows, the stalk components, in comparably arranged rows, being brought into frontal contact or engagement on the head side with these shaping elements. In the process the sonotrodes and/or the counterhold element for a particular shaping process preferably move up and down, the backing element moving in a direction transverse thereto between a shaping zone in the form of sonotrodes and counterhold element, as soon as the shaping elements are disengaged from the head components to be shaped. Consequently, the shaping process may be carried out in series and so continuously and undesirable slippage between backing element and shaping tool is prevented.

In an especially preferred embodiment of the process claimed for the invention the shaping elements are provided with incisions and/or profile recesses and/or embossings. This makes it possible to impart a structure to the top of the head such as a sandpaper-like roughness comparable to the structuring calender rollers disclosed in PCT/WO 00/41479. If the profile recesses in the shaping tool are characterized by a very fine structure, a microstructure with the most minute of embossings may be formed on the top side of the head component treated in this manner, so that a self-cleaning surface is formed to which fouling particles cannot adhere. If the respective shaping element is provided with an embossing design, for example, one like cutting knives, the surface of the head is partially incised and the respective edges of the head components reach further downward in the direction of the base of the stalk than with conventional solutions. The latter, that is the deeper positioning of the edge, then has an especially favorable effect in increasing the shell strength values for the entire adherent fastening.

Additional advantageous embodiments are specified in the other subsidiary claims.

The process claimed for the invention is described in greater detail in what follows with reference to the drawing, in which

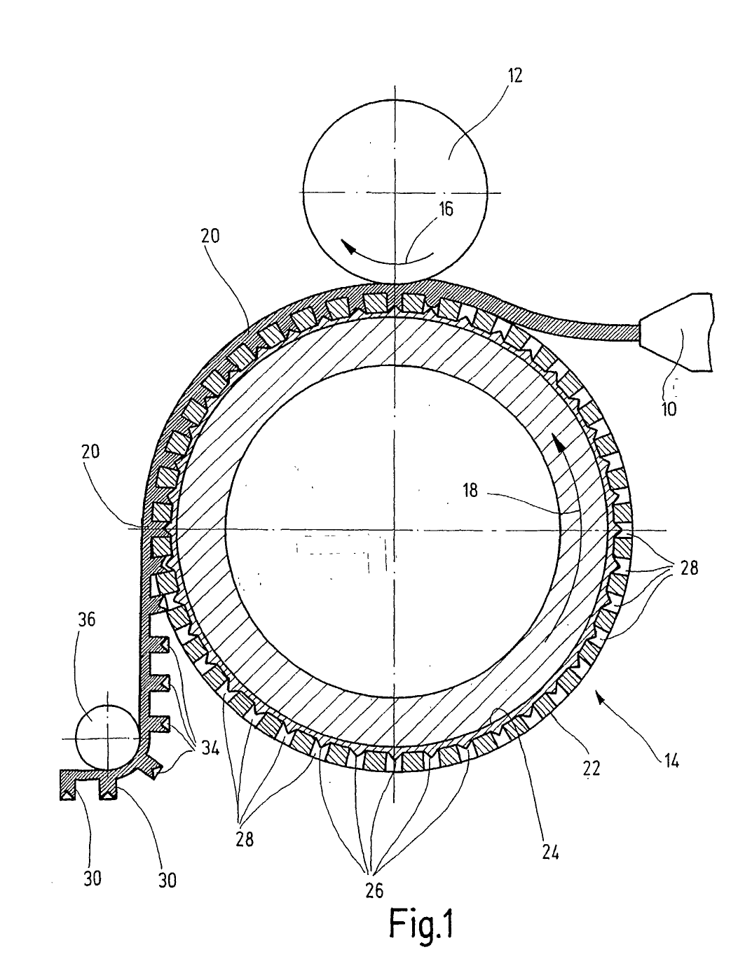

FIG. 1 presents a greatly simplified and partly cut away side view of a device for application of a preshaping process;

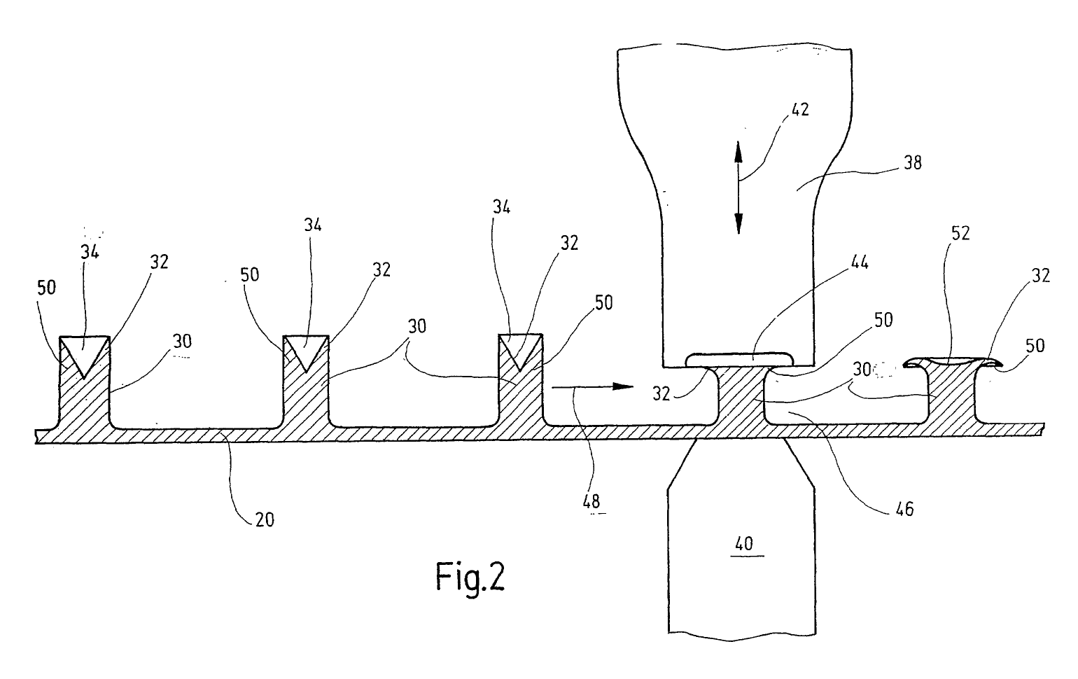

FIG. 2 an also greatly simplified and partly cut away side view of a shaping process applying ultrasound which is carried out after the shaping process shown in FIG. 1.

FIG. 1 presents in diagram form parts of a device for conduct of a preforming stage for the subsequent shaping process itself claimed for the invention. The device shown in FIG. 1 has an extruder head 10 as feeding mechanism for a thermoplastic material in a pulp, plastic, pasty, or liquid state which corresponds to a strip or sheet whose width corresponds to that of the adherent fastening to be produced, the strip or sheet being fed to the gap between a pressure tool and a shaping tool. A pressure roller 12 is provided as pressure tool. The shaping tool is represented by a shaping roller identified as a whole by 14. Both rollers are driven in the directions of rotation indicated by the curved arrows 16,18 in FIG. 1, so that a feed gap is formed between them through which the strip of plastic is fed in the direction of conveyance, while at the same time the strip of plastic for the backing element 20 of the adherent fastening element is shaped and the backing 20 on the side adjacent to the shaping roller 14 receives the shape required for formation of interlocking elements through the preshaping elements of the shaping roller 14.

For this purpose the shaping roller 14 has on its circumference two preshaping elements, one in the form of an outer sieve 22 and one in the form of a sheet 24 with outer elevations in the form of projections 26 adjacent to the inside of the sieve 22. These projections 26 are aligned with the cavities 28 in the outer sieve 22. The outer sieve 22 preferably consists of a thicker material, for example, of a thickness of several tens of millimeters, while the inner sheet 24 is substantially thinner, having a thickness of 0.1 mm, for example. In addition, the projections 26 may be conical, pyramidal, or stellate in form and may be produced preferably by etching or galvanizing, as is also the case with cutting sheets for rotary stamping devices. Shapes with flank angles of about 60° are produced in the process. Spiked rollers with a fabric-reinforced rubber base 3 to 8 mm thick may also be used. The inner sheet 24 is preferably flexible in form in order to permit integration with the shaping roller 14. The sheet 24 may also be applied to the shaping roller 14 under its inherent stress and adhesion or the like is not absolutely necessary.

On the basis of the configuration indicated, the plastic pressed into the cavities 28 closed by projections 26 in the gap between the pressure roller 12 and the shaping roller 14 is shaped in such a way that stalk components 30 projecting above the backing element 20 are produced on whose free end a head component 32 is mounted, each of which components 30 has a small indentation 34 of the nature of a funnel. The indentation 34 in question results from the air trapped between the plastic material to be shaped and the shaping walls of the shaping rollers 14. After partial or complete setting of the plastic materials the stalk components 30 are extracted from the shaping roller 14 by a drawing roller 36.

The strip material thereby obtained is then subjected to another shaping process as claimed for the invention. FIG. 1 presents a shaping process for the stalk and head components only as an example. But in principle any adherent fastening material may be subjected to a further ultrasonic shaping process as illustrated in FIG. 2. The initial material obtained as shown in FIG. 1 for an adherent fastening material is now subjected to the additional shaping process as illustrated in FIG. 2. The respective shaping process claimed for the invention is operated with ultrasound or ultrasonic waves in order to obtain various head geometries and/or various head shapes. The shaping process employing ultrasound is in this instance comparable in execution to an ultrasonic welding process; a sonotrode 38 used in conjunction with a counterhold element 40 (anvil) represents the shaping tool proper. By preference the counterhold element 40 assumes a stationary position by way of which the striplike backing element 20 moves continuously from right to left as viewed in the line of sight in FIG. 2, while the sonotrode 38 is moved up and down at the same rate in the direction of the double arrow 42. In addition, the sonotrode 38, as viewed in the line of sight to FIG. 2, has on its bottom side individual shaping elements 44 by which the assignable head shapes may be produced.

The sonotrode 38 is in the form of a shaping strip (not shown), and a plurality of shaping elements 44 are mounted along the sonotrode 38 in a row in a plane perpendicular to the plane of the sheet as illustrated in FIG. 2. In addition, the stalk components 30, in at least one row of comparable arrangement, are brought into frontal contact or engagement on the head side with these shaping elements 44 as soon as they come to be positioned below these elements on the counterhold element 40.

Unlike the layout shown in FIG. 2, in an embodiment not shown the counterhold element may replace the sonotrode 38 and be provided with appropriate heatable shaping elements 44, while the sonotrode 38 moves up and down as viewed in the line of sight to FIG. 2 below the backing element 20 for a shaping process. In the process the strip material retains its orientation as shown in FIG. 2. The counterhold element 40 may in this instance be heated for both embodiments. This makes it possible to introduce energy into the adherent fastening material with the backing element 20 at two opposite positions. As a result of the uniform introduction of energy and heat, an especially gentle shaping process is achieved and adherent fastening material homogenous in structure is obtained. A shaping strip extending in a straight line, with the partitions omitted, may also be formed in place of individual shaping elements 44. In a situation such as this the spacing between stalk components 30 of a row may vary without harming the manufacturing accuracy. In the embodiment shown in FIG. 2 the shaping element 44 involved is more or less in the form of a flat recess inside the sonotrode 38. The respective shaping element 44 could, however, be provided in the form of a concave recess (not shown) in the lower free end of the sonotrode 38. In a situation such as this head components convex in shape (not shown) would be obtained. The latter configuration would present the advantage that a coating or looping material of a corresponding adherent fastening element placed in position would slide off the top of the head and necessarily adhere to the top edge, so that loops would increasingly be engaged with the interlocking means and not remain stationary above on the free ends of the heads. The peel strength values in particular for the fasteners in question would be distinctly increased by such measures.

If the sonotrode 38 is moved downward in the line of sight to FIG. 2 into its operating position, the shaping element 44 covers the upper area of the head component 32; with the sonotrode 38 lowered in this manner, a shaping zone 46 is formed between the sonotrode 38 and the counterhold element 40. If the sonotrode 38 oscillates at 20 kHz with an amplitude preferably of 30 μm, the backing element 20 may be continuously moved one row of interlocking means at a time in the direction indicated by the arrow 48 further to the right and, as viewed in the line of sight to FIG. 2, is entirely to the right of the head component 32 production of which has now been completed. The latter is characterized in that the head component lips 50, which initially project steeply upward, form a widened flat edge; this edge extending downward in the direction of the base of the stalk distinctly improves potential interlocking with a looping material or the like. A concave recess 52 which may be filled with a dye, an adhesive, an antibonding agent, or the like (not shown) remains in the center of the head element 32.

It is especially advantageous to provide at the base of the respective shaping element 44 an embossed design, for example, in the form of intersecting individual cuts (not shown) which produce an axial and circumferential knurl pattern or the like in the head component 32 made later. As a result of the respective incisions on the free end of the head component 32 the head component material is weakened and the shaping edge is folded even further downward along the respective cutting line, so that the interlocking edge of the respective head component 32 may also have a sharply indented interlocking pattern; this results in better bonding with the looping material already referred to. Consequently, the peel strength values for conventional adherent fastening elements can be distinctly increased in this way. The bottom of the sonotrode 38 and thus the shaping elements themselves 44 can be produced with high precision, so that the manufacturing tolerances for the head components 32 are assigned low values relative to the previously customary calender rollers with their synchronization problems and with their delay of material, especially in the event that the calender roller is correspondingly heated. It has been proved to be especially favorable to operate the sonotrode 38 in a frequency range of 17 to 20 kHz, with an amplitude range preferably ranging from 1 μm to 100 μm. Preferably provision is also made such that the plastic material is in the form of a biodegradable thermoplastic or of another plastic material which can be easily processed and easily recycled. It is also advantageous to place the heat generated in the process of ultrasonic shaping of the plastic material in the area of the associated Vicat number of this plastic material, so that thermal stability is ensured even when the material is subjected to heating.

In an embodiment not shown in detail the striplike backing element 20 may also be conducted in a circle over the upper side of the counterhold element 40 (anvil). The upper control surface of the counterhold element (40) preferably is not in the form of a flat plate, but rather is convex in shape. The respective shaping element 44 is correspondingly associated, then being uniformly concave in the form of a striplike shaping zone. In addition, provision can also be made such that a plurality of sonotrodes 38 alternate in processing the adherent fastening material or such that a plurality of shaping rows and shaping elements 44 positioned adjacent to each other permit simultaneous processing of a plurality of rows of juxtaposed stalk components 30. Moreover, only a part of the shaping elements 44 may have profile elements such as cutting knives or the like.

In addition, the ultrasound shaping process makes it entirely possible to create so-called back-to-back adherent fastening elements, that is, ones which may have adherent fastening, especially interlocking, elements on the upper as well as the lower side. In one case of this nature not just the sonotrode 38 has a corresponding shaping element, but the counterhold element 40 mounted opposite the sonotrode has one as well. In addition, the energy to be introduced by the sonotrode is to be selected so that shaping may be carried out on both sides of the backing element 20.

1. A process for production of an adhering fastening element from plastic materials with a striplike or sheetlike backing element (20) which is provided on at least one of its two sides with a plurality of interlocking elements each of which has a head component (32) which is connected to the backing element (20) by means of a stalk component (30), a thermoplastic shaping process which acts on the free ends of the stalk components (30), which are widened opposite the stalk components (30), being applied in order to obtain head components (32) of different geometric configurations, characterized in that the thermoplastic shaping process is carried out by means of ultrasound and in that shaping of the head components is carried by means of a shaping tool in contact with the free ends of the stalk components (30).

2. The process as specified in claim 1, wherein a sonotrode (38) and/or a counterhold element (40) for the sonotrode (38) with individual shaping elements (44) by means of which the assignable head shapes for the head components (32) are produced is/are employed as shaping tool.

3. The process as specified in claim 2, wherein the shaping elements (44) are arranged in at least one assignable row relative to each other along the sonotrode (38) and wherein the stalk components (30) in at least one row of comparable arrangement are brought into frontal contact or into engagement on the head side with these shaping elements (44).

4. The process as specified in claim 2 or 3, wherein the sonotrode (38) and/or the counterhold element (40) move up and down for the particular shaping process and wherein the backing element (20) is moved back and forth in a direction transverse thereto through a shaping zone made up of sonotrode (38) and counterhold element (40) as soon as the shaping elements (44) are disengaged from the head components (32) to be shaped.

5. The process as specified in one of claims 1 to 4, wherein the shaping elements (44) are provided with incisions and/or profile recesses and/or projections.

6. The process as specified in one of claims 2 to 5, wherein the sonotrode (38) is operated in a frequency range of 1 kHz to 1 MHz, preferably in the frequency range of 17 to 20 kHz, and wherein the amplitude range selected is preferably between 1 μm and 100 μm.

7. The process as specified in one of claims 2 to 6, wherein the counterhold element (40) is heated by means of a heating device.

8. The process as specified in one of claims 1 to 7, wherein, in a process section inserted upstream from the ultrasound shaping process, a thermoplastic material in pulpy, plastic, pasty or liquid state is introduced into a gap between a pressure roller (12) and a shaping roller (14) and these rollers are operated so that the backing element (20) is shaped in the gap and guided in a conveying direction in which a sieve (22) having through openings (28) is used as preshaping element on the shaping roller (14) and in which the interlocking elements are formed at least in part in that the plastic sets at least to some extent in the through openings (28) of the sieve (22) and in that such a shaping roller (14) is employed which has on the side of the sieve (22) facing away from the pressure roller (12) a second preshaping element (24,26) operated in conjunction with the through openings (28) of the sieve (22) by which preshaping element (24, 26) the plastic material is shaped in the area of the outer ends of the stalk components (30).

9. The process as specified in claim 8, wherein the heating of the plastic material introduced by the ultrasound shaping process is situated in the area which may be associated with the Vicat number of this plastic material.

10. The process as specified in claim 8 or 9, wherein the plastic material employed is in the form of a biologically degradable thermoplastic.
